(19) United States
(12) Patent Application Publication
(10) Pub. No.: US 2023/0149945 A1
(43) Pub. Date: May 18, 2023

(54) Method and System for Facilitating Green Screening, Classification, and Adsorption of Target Elements from a Mixture

(71) Applicant: Royal Biotech Inc, Beverly Hills, CA (US)

(72) Inventors: Philip Huang, Westlake Village, CA (US); E-Ray Huang, Westlake Village, CA (US)

(21) Appl. No.: 18/055,948

(22) Filed: Nov. 16, 2022

Related U.S. Application Data
(60) Provisional application No. 63/280,498, filed on Nov. 17, 2021.

(51) Int. Cl. B03B 9/06; B03D 1/02; B03B 5/30; B03B 13/02; B03C 1/30; B03C 1/01

(52) U.S. Cl. CPC B03B 9/061; B03D 1/028; B03B 5/30; B03B 13/02; B03C 1/30; B03C 1/01; B03C 2201/18

(57) ABSTRACT

The method of the present invention receives a mixture. The method then separates clay and metal within in the mixture. The method then treats pollutants or toxins within in the mixture with magnetic beads. The method then treats the pollutants or toxins using nano-bubbles generated by a 3-in-1 bubble generator. Further, the method screens and classifies the tiny particles within in the mixture based on magnetic separation. Next the method screens and classifies the tiny particles within in the mixture based on gravity separation. The gravity separation includes an anti-leakage net underneath the grinding system. The anti-leakage net avoids loss and collects and resets the leakage into a feeding port connected to the gravitational device. Furthermore, the method screens and classifies the tiny particles within in the mixture based on floatation. Finally, the method collects the target element and rare earth elements (REE).

### FIELD OF THE INVENTION

The present invention relates generally to classifying, separating, and assorting solids. More specifically, the present invention is methods, systems, apparatuses, and devices for facilitating green screening, classification, and adsorption of target elements from a mixture.

### BACKGROUND OF THE INVENTION

The field of classifying, separating, and assorting solids is technologically important to several industries, business organizations, and/or individuals. In particular, the use of classifying, separating, and assorting solids is prevalent for facilitating green screening, classification, and adsorption of target elements from a mixture.

For hundreds of years, humans have often used floatation or leaching to screen target metals, usually grinding the incoming material to less than 0.3 mm, and this kind of method is more suitable for the screening of fine particles than gravity separation, but it is not fully suitable for too fine particles 500 mesh or more. Using a shaker table screened & classified material (e.g.: mineral, sludge, WEEE,), it is very common for a shaker to be used for recovery and can be high-efficiency classification screening. The shaker table has the limitations of the incoming material if the material is soluble in water. If the material is compatible with water, it is not suitable for use. Further, if the density is lower than 4.0, it is not suitable for use. Further, if the volume of the incoming material is too large or small, such as 20 mesh or less, 500 mesh or more, it is not suitable for use.

Generally, many mines often include a variety of elements or metal symbiosis. Further, the mine mixed with clay composition often leads to the metal particles in the incoming materials to increase the difficulty of separation and recovery efficiency reduction. Further, currently commonly used chemical methods to separate may lead to alternative environmental pollution problems. Further, for screening heavy metals and other elements, if the incoming material is mixed with a high proportion of clay, it may lead to reduced recovery rates using common screening methods (e.g.: floatation method, gravity method, etc.) because clay composition may tightly wrap the metal particles which in turn affects the return on investment coupled with the current global trend towards earth protection & ecological maintenance. Also, the distribution of rare earth elements (Sc, Y, La, Ce,) in the earth's crust is quite scattered, and few rare earth elements are concentrated in deposits that allow commercial exploitation. Rare earth elements are a mixture of many elements, and it is difficult to separate each element. Rare earth element (REE) screening causes great environmental pollution & health hazards (for example, high toxicity for biotic components). So how to use greening, separating clay from metals or rare earth elements will be more important.

From 1915 to today, more than 30,000 tailings ponds have accumulated, and more than 3,000 are in danger, and contains a lot of residual metal or important elements. Although some have been covered with houses, there are more than 70% of the idle in there, seriously affecting the local environment or ecology, for example, rain causes tailings to overflow, enter rivers or groundwater layers, and even into food supply chains, thereby endangering the health of residents. Over the next five years, the mining industry will produce an additional 40 billion to 50 billion tons of tailings (95 billion to 120 billion cubic meters). Further, by 2025, the world's total tailings may reach 640 billion cubic meters. Because many tailings or raw ore make use of floatation method, leaching method, gravity method, magnetic method but it is difficult for the current industrialization technology, to continue to screen clean (eat dry wipe clean) resulting in a considerable amount of metal residue. Further, the particles of metal residue are too subtle (even to RED CELL size) or too low density to screen for recycling. In addition, Waste from Electrical and Electronic Equipment (WEEE) contains metal elements such as gold, iron, silver, copper, platinum, and palladium, as well as rare earth elements such as palladium, vanadium, glass, and plastic. Although these elements are small in each phone—one phone, for example, contains only 0.034 grams of gold. Further, the world generated 42 million tons of e-waste in 2014 alone. According to estimates by the United Nations Environment Program, this figure is increasing by 3-5 percent per annals—the number of resources contained in used mobile phones is extremely large. The recovery of various metals or rare earth elements by tailings or WEEE can not only provide the raw materials needed for industrial development but also reduce the number of new mining areas developed by human beings and reduce ecological damage.

Therefore, there is a need for improved methods, systems, apparatuses, and devices for facilitating green screening, classification, and adsorption of target elements from a mixture that may overcome one or more of the above-mentioned problems and/or limitations.

### BRIEF DESCRIPTION OF THE DRAWINGS

FIG. 1 is flowchart of the present invention method.

FIG. 2 is flowchart of a subprocess of the present invention method.

FIG. 3 is flowchart of a subprocess of the present invention method.

FIG. 4 is flowchart of a subprocess of the present invention method.

FIG. 5 is flowchart of a subprocess of the present invention method.

FIG. 6 is flowchart of a subprocess of the present invention method.

FIG. 7 is flowchart of a subprocess of the present invention method.

FIG. 8 is flowchart of a subprocess of the present invention method.

FIG. 9 is flowchart of a subprocess of the present invention method.

FIG. 10 is flowchart of a subprocess of the present invention method.

FIG. 11 is flowchart of a subprocess of the present invention method.

FIG. 12 is a block diagram of the present invention system.

### DETAIL DESCRIPTIONS OF THE INVENTION

All illustrations of the drawings are for the purpose of describing selected versions of the present invention and are not intended to limit the scope of the present invention.

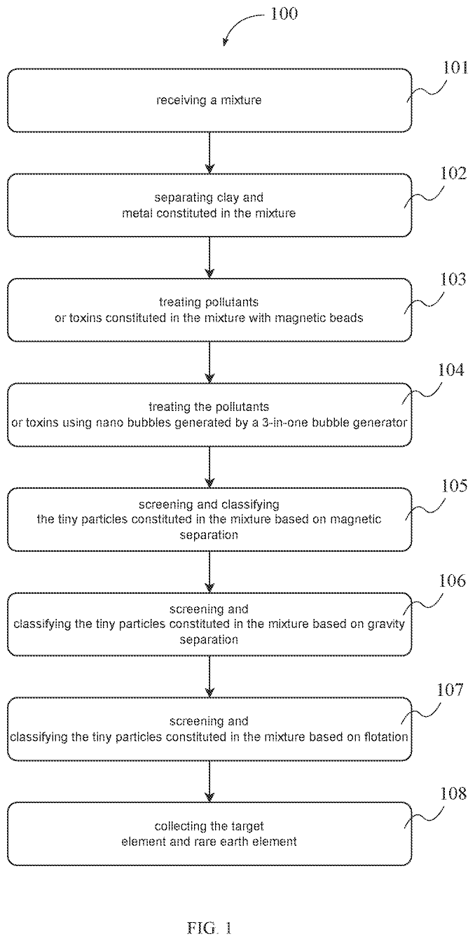

As can be seen in FIG. 1 through FIG. 12, the preferred embodiment of the present invention is a method 100 and system 1200 for facilitating green screening, classification, and adsorption of target elements from a mixture. The first step 101 of the method of the present invention receives a mixture. A mixture is a combination of elements and particles including both rare earth elements and waste. Additionally, the method has a step 102 that separates clay and metal constituted in the mixture. The method has a step 103 that then treats pollutants or toxins constituted in the mixture with magnetic beads. The toxins are elements that are unwanted within the final product that could potentially corrode the rare earth element (REE) or harm an individual that comes in contact with the mixture still containing toxins. The method has a step 104 that then treats the pollutants or toxins using nano bubbles generated by a 3-in-1 bubble generator. The bubble generator is a bubble production machine that produces Ultra-fine bubbles or micro-bubbles for recovery within with tailing, and waste from electrical and electronic equipment (WEEE)/REE particles with a mesh between 230 and 4,800 through the floating filtering method. The UFB-Ultra-Fine Bubble explosion principle may be used to destroy the structure of pollutants (e.g. pesticides or chemical agent residues) contained in incoming materials to remove pollution. Further, the method has a step 105 that screens and classifies the tiny particles constituted in the mixture based on magnetic separation. The magnetic separation usually uses high gradient fields to recover different materials. The tiny particles have a low density or size that make screening difficult. Next the method has a step 106 that screens and classifies the tiny particles constituted in the mixture based on gravity separation. The gravity separation includes an anti-leakage net underneath the grinding system. The anti-leakage net avoids loss and collects and resets the leakage into a feeding port connected to the gravitational device. Furthermore, the method has a step 107 that screens and classifies the tiny particles constituted in the mixture based on floatation. Finally, the method has a step 108 that collects the target element and rare earth elements (REE).

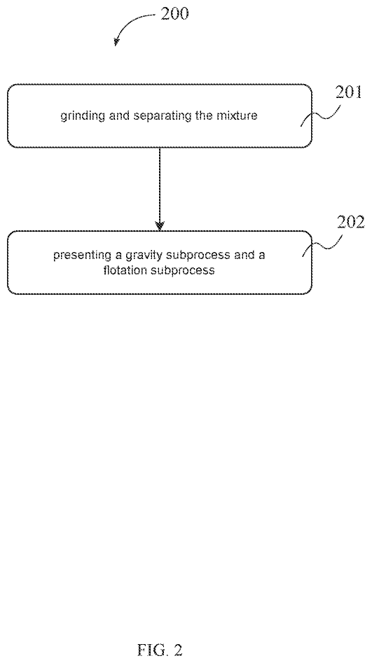

In reference to FIG. 2, a sub-process 200 of the method of the present invention enables a mixture to be grinded before filtration. To that end, the sub-process begins with a step 201 by grinding and separating the mixture. As a result, the ground mixture is easier to be separated and filtered through when smaller than 0.3 mm and creating a more uniform mixture. The sub-process continues with a step 202 by presenting a gravity subprocess and a floatation subprocess. Based on the specifications of the mixture separation of the mixture may be better suited for gravity or floatation.

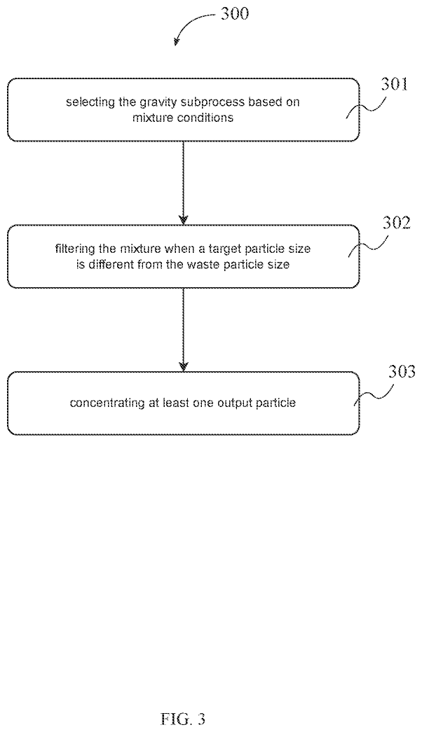

In reference to FIG. 3, a sub-process 300 of the method of the present invention enables the present invention to filter out a target particle size. To that end, the sub-process begins with a step 301 by selecting the gravity subprocess based on mixture conditions. The mixture conditions are based on a physical specificity, chemical specificity, biological specificity, and digital specificity. The sub-process continues with a step 302 by filtering the mixture when a target particle size is different from the waste particle size. Accordingly, if the particle sizes differ a screening device can be utilized to separate the two different sized particles with the threshold being smaller than the unwanted particle size and bigger than the wanted particle size or vise versa. The sub-process continues with a step 303 by concentrating at least one output particle. Centrifugation is a technique that separates particles from a mixture based on their size, shape, density, viscosity of the medium, and rotor speed. A centrifugal device is connected at an outlet port of a shaker device to produce concentrate from each outlet to further filter and separate the mixture. High speed centrifugal measured may be used to separate based on differences in density or weight.

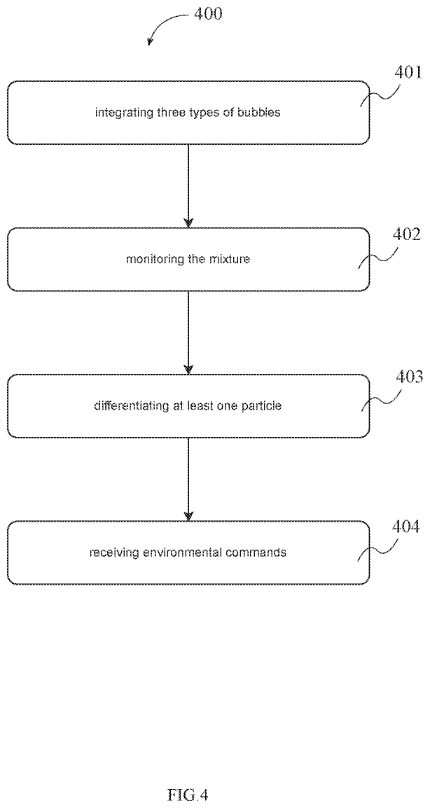

In reference to FIG. 4, a sub-process 400 of the method of the present invention enables a mixture to be filtered utilizing various sized bubbles. To that end, the sub-process begins with a step 401 by integrating three types of bubbles. Consequently, three types of bubbles are added through the 3-in-1 generator. The 3-in-1 generator can create bubbles, micro bubbles and nano bubbles. The 3-in-1 generator can be adjusted to adjust the bubble size and emission order to target specific particles within the mixture. The 3-in-1 generator is specifically designed for floatation separation that improved recovery rates and the efficiency of the removal of dyes. The 3-in-one generator further can solve microbubbles in a liquid and use properties of a vortex pump turbine to effectively solve gas with a liquid or two liquids while adding it under pressure. The sub-process continues with a step 402 by monitoring the mixture. The mixture is observed to ensure any changes in characteristics are noted. The sub-process continues with a step 403 by differentiating at least one particle. The sub-process continues with a step 404 by receiving environmental commands. Based off of any changes to the mixture observed by the photographic observation system 1210 an artificial intelligence system sends commands to automatically or semi-automatically control an environment. The photographic observation system 1210 includes an electron microscope 1211, camera 1213, and infrared device 1212. The photographic observation system 1210 differentiates particles using X-Ray and Near Infrared technologies.

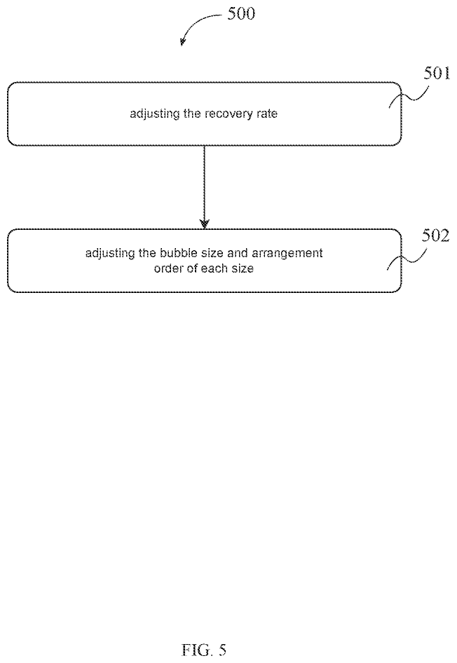

In reference to FIG. 5, a sub-process 500 of the method of the present invention enables a 3-in-1 generator 1231 to be adjusted. To that end, the sub-process begins with a step 501 by adjusting the recovery rate. The 3-in-1 generator 1231 can be specifically designed for floatation separation which can then improve recovery rates. The 3-in-1 generator 1231 alters the buoyancy of the bubbles that affects the recovery rate. The sub-process continues with a step 502 by adjusting the bubble size and arrangement order of each size. The 3-in-1 generator 1231 alters the bubble size and emission order to match with the target particles for floatation.

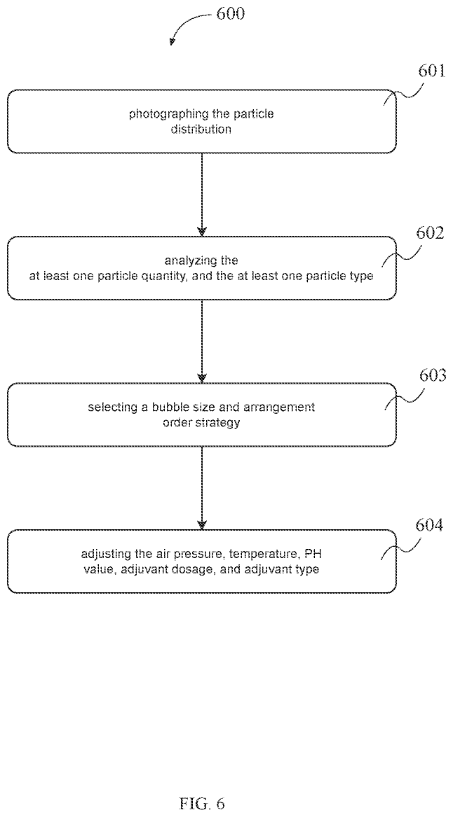

In reference to FIG. 6, a sub-process 600 of the method of the present invention enables a target particle to be monitored. To that end, the sub-process begins with a step 601 by photographing the particle distribution. As a result, the particles are able to be differentiated easier. The sub-process continues with a step 602 by analyzing the at least one particle size, the at least one particle quantity, and the at least one particle type. Accordingly, the type of particle can be determined creating criteria necessary for proper separation. The sub-process continues with a step 603 by selecting a bubble size and arrangement order strategy. The bubble size is then selected based on the target particle criteria and a bubble emission order is selected based on the target particle criteria. The sub-process continues with a step 604 by adjusting the air pressure, temperature, PH value, adjuvant dosage, and adjuvant type. Consequently, the environment is adjusted for what is most suitable for the target particle within the floatation device 1230.

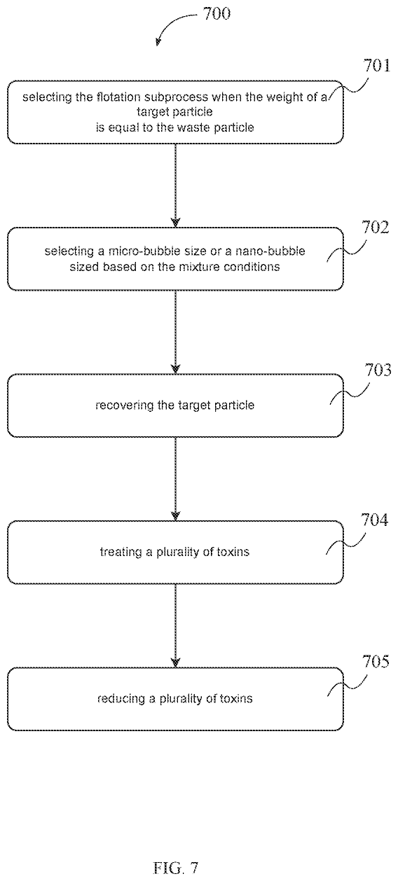

In reference to FIG. 7, a sub-process 700 of the method of the present invention enables particle recovery utilizing magnetization. To that end, the sub-process begins with a step 701 by selecting the floatation subprocess when the weight of a target particle is equal to the waste particle. When the weight of two particles being compared is similar centrifugation may not be applicable and floatation separation may be used. The sub-process continues with a step 702 by selecting a micro-bubble size or a nano-bubble sized based on the mixture conditions. For example, for particularly fine particles, the floatation separation my use ultra-fine bubbles or micro bubbles to filter the particles out of the mixture. The sub-process continues with a step 703 by recovering the target particle. The recovery can be targeted to REE or heavy metals according to the specificity of components within the tailings or mixture. The sub-process continues with a step 704 by treating a plurality of toxins. The sub-process continues with a step 705 by reducing a plurality of toxins. The plurality of toxins can be treated and reduced utilizing nano-bubbles from the 3-in-1 generator 1231. The subprocess may utilize the ultra-fine bubble explosion principle to destroy the structure of at least one toxin contained in the incoming materials within the mixture. The at least toxins could be pesticides, chemical agent residues, and amongst other elements.

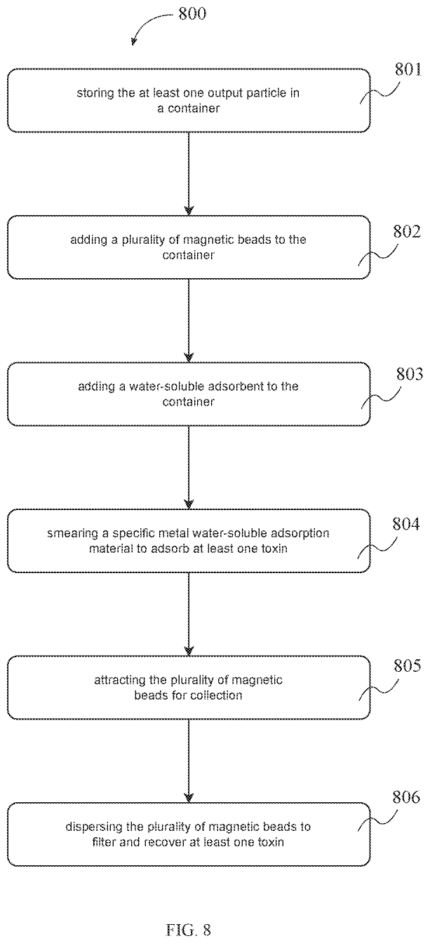

In reference to FIG. 8, a sub-process 800 of the method of the present invention enables removing particles from a mixture. To that end, the sub-process begins with a step 801 by storing the at least one output particle in a container. The sub-process continues with a step 802 by adding a plurality of magnetic beads to the container. The plurality of magnetic beads is usually 20-30 nm for adsorption methods that include adsorbing target toxins. The sub-process continues with a step 803 by adding a water-soluble adsorbent to the container. The sub-process continues with a step 804 by smearing a specific metal water-soluble adsorption material to adsorb at least one toxin. As a result, the target plurality of toxins is adsorbed within the container. The sub-process continues with a step 805 by attracting the plurality of magnetic beads for collection. The sub-process continues with a step 806 by dispersing the plurality of magnetic beads to filter and recover at least one toxin. So, the mixture is exposed to a magnetic field switch design that draws the plurality of magnetic beads to one side of the container. The plurality of magnetic beads is then dissolved with the plurality of adsorbed toxins within water and the remaining toxins are collected with a standard filter screen.

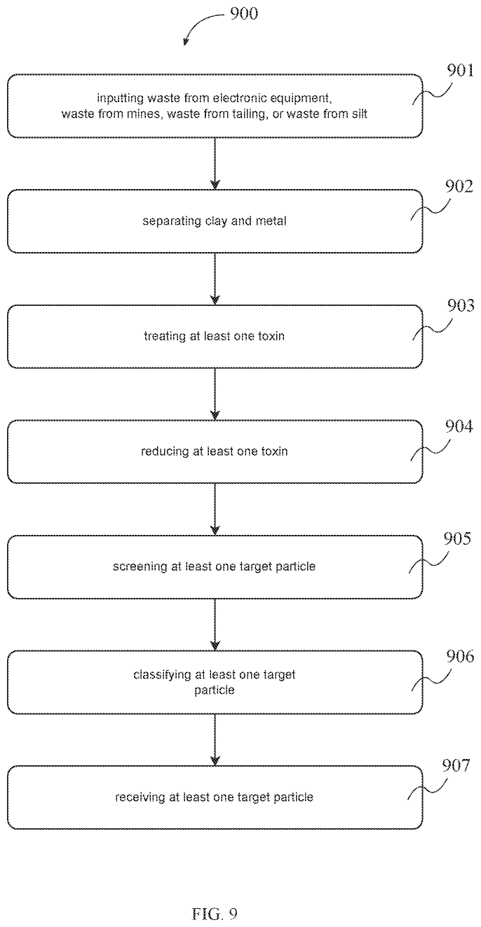

In reference to FIG. 9, a sub-process 900 of the method of the present invention enables filtering utilizing a gravitational device 1220. To that end, the sub-process begins with a step 901 by prompting inputting waste from electronic equipment, waste from mines, waste from tailing, or waste from silt. The waste may further include clay and various metals. The sub-process continues with a step 902 by separating clay and metal. The sub-process continues with a step 903 by treating at least one toxin. The sub-process continues with a step 904 by reducing at least one toxin. The plurality of toxins can be treated and reduced with similar methods previously disclosed utilizing the 3-in-1 generator 1231. The sub-process continues with a step 905 by screening at least one target particle. The sub-process continues with a step 906 by classifying at least one target particle. As a result, the target particle is categorized into a particle type. The sub-process continues with a step 907 by receiving at least one target particle.

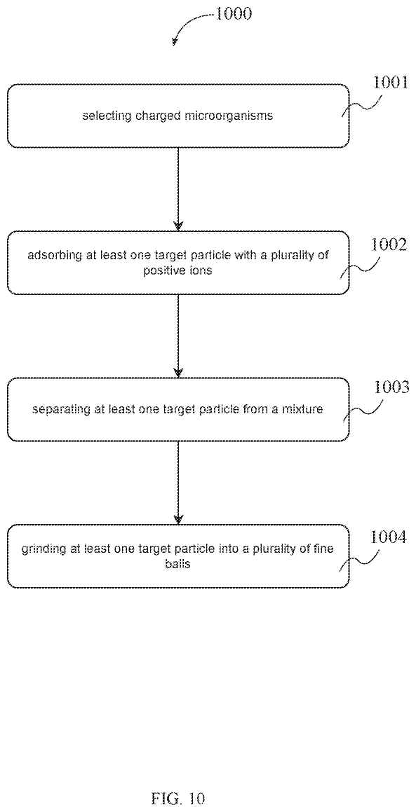

In reference to FIG. 10, a sub-process 1000 of the method of the present invention enables filtration with a biological device 1260. To that end, the sub-process begins with a step 1001 by selecting charged microorganisms. The biological device 1260 can further produce a specific plurality of microorganisms that is charged for efficient incubation, decomposing, and repelling the originally negatively charged clay on the surface. The sub-process continues with a step 1002 by adsorbing at least one target particle with a plurality of positive ions. As a result, the clay is separated from the specific metal or REE. The sub-process continues with a step 1003 by separating at least one target particle from a mixture. The sub-process continues with a step 1004 by grinding at least one target particle into a plurality of fine balls. As required the physical and mechanical methods are combined to create a finely ground uniform target particle.

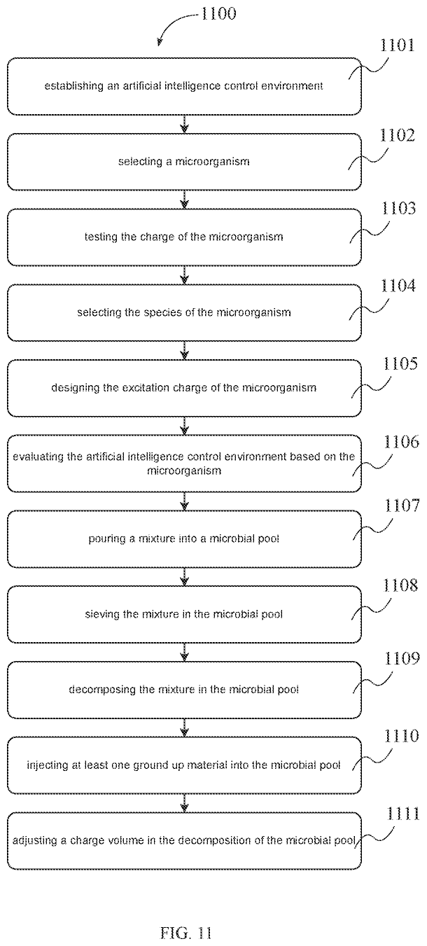

In reference to FIG. 11, a sub-process 1100 of the method of the present invention enables biological filtration with artificial intelligence. To that end, the sub-process begins with a step 1101 by establishing an artificial intelligence control environment. The sub-process continues with a step 1102 by selecting a microorganism. The biological device 1260 is used to separate clay and REE with a microorganism that is charged for efficient incubation, decomposing, and repelling the originally negatively charged clay on the surface. The sub-process continues with a step 1103 by testing the charge of the microorganism. For example, general soil or clay often has a negative charge on the surface, and electrostatically charged cations (e.g., manganese, potassium, calcium, sodium, etc.) are attracted to the surface of the clay particles. Clay has the characteristics of strong tension in contact with water unless the water causes expansion, and the tight tension is reduced (like balloon inflation to rupture). The sub-process continues with a step 1104 selecting the species of the microorganism. The sub-process continues with a step 1105 designing the excitation charge of the microorganism. The clay and REE separation may include excitation where the charge volume is adjusted in the microbial pool. The sub-process continues with a step 1106 by evaluating the artificial intelligence control environment based on the microorganism. The sub-process continues with a step 1107 by pouring a mixture into a microbial pool. The microbial pool is utilized for sieving and decomposition for particle of different sizes and may comprise a plurality of discharge ports. The sub-process continues with a step 1008 by sieving the mixture in the microbial pool. The sub-process continues with a step 1109 by decomposing the mixture in the microbial pool. The sub-process continues with a step 1110 by injecting at least one ground up material into the microbial pool. The sub-process continues with a step 1111 by adjusting a charge volume in the decomposition of the microbial pool.

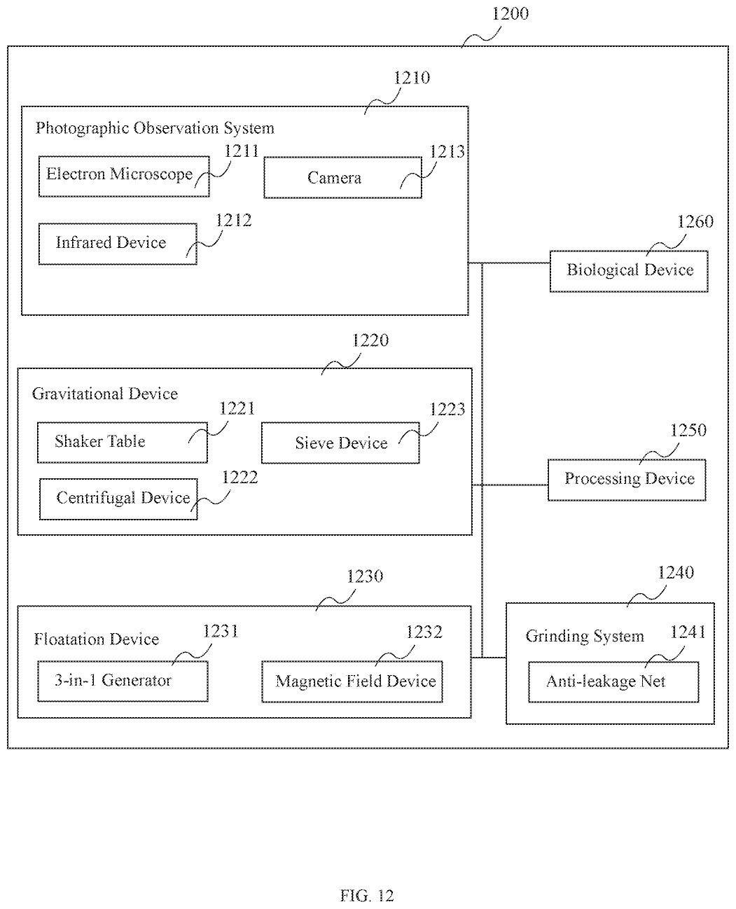

FIG. 12, illustrates a block diagram of a system 1200 for facilitating green screening, classification, and adsorption of target elements from a mixture, in accordance with some embodiments. The system comprises a processing device 1250, a photographic observation system 1210, a gravitational device 1220, a floatation device 1230, a grinding system 1240, and a biological device 1260. The photographic observation system 1210 further comprising an electron microscope 1211, a camera 1213, and an infrared device 1212. The gravitational device 1220 further comprising a shaker table 1221, a sieve device 1223, and a centrifugal device 1222. The floatation device 1230 further comprising a 3-in-1 generator 1231 and a magnetic field device 1232. The grinding system 1240 further comprising an anti-leakage net 1241. Further the processing device 1250 may be configured for presenting a gravity subprocess and a floatation subprocess. Further the processing device 1250 may be configured for selecting the gravity subprocess based on mixture conditions. Further the processing device 1250 may be configured for analyzing the at least one particle size, the at least one particle quantity, and the at least one particle type. Further the processing device 1250 may be configured for selecting a bubble size and arrangement order strategy. Further the processing device 1250 may be configured for selecting the floatation subprocess when the weight of a target particle is equal to the waste particle. Further the processing device 1250 may be configured for selecting charged microorganisms. Further the processing device 1250 may be configured for establishing an artificial intelligence control environment. Further the processing device 1250 may be configured for selecting a microorganism. Further, the system may include a grinding system 1240 communicatively coupled with the processing device 1250. Further the grinding system 1240 may be configured for grinding and separating the mixture. Further the grinding system 1240 may be configured for grinding at least one target particle into a plurality of fine balls. Further the grinding system 1240 may be configured for adjusting, using the biological device 1260, a charge volume in the decomposition of the microbial pool. Further, the system may include a sieve device 1223 mechanically coupled with the grinding system 1240. Further, the sieve device 1223 may be configured for filtering the mixture when a target particle size is different from the waste particle size. Further, the sieve device 1223 may be configured for dispersing, using the sieve device 1223, the plurality of magnetic beads to filter and recover at least one toxin. Further, the system may include a centrifugal device 1222 mechanically coupled with the grinding system 1240. The centrifugal device 1222 may be configured for concentrating at least one output particle. Further, the system may include a 3-in-1 generator 1231 mechanically coupled with the grinding system 1240. The 3-in-1 generator 1231 may be configured for integrating three types of bubbles. The 3-in-1 generator 1231 may be configured for adjusting the recovery rate. The 3-in-1 generator 1231 may be configured for adjusting the bubble size and arrangement order of each size. The 3-in-1 generator 1231 may be configured for adjusting the air pressure, temperature, PH value, adjuvant dosage, and adjuvant type.

Further, the system 1200 may include a photographic observation device communicatively coupled with the processing device 1250. Further, the photographic observation device may be configured for monitoring the mixture. Further, the photographic observation device may be configured for differentiating at least one particle. Further, the photographic observation device may be configured for receiving environmental commands. Further, the photographic observation device may be configured for photographing the particle distribution. Further, the system may include a floatation device 1230 mechanically coupled with the grinding device. Further, the floatation device 1230 may be configured for selecting a micro-bubble size or a nano-bubble sized based on the mixture conditions. Further, the floatation device 1230 may be configured for treating a plurality of toxins. Further, the floatation device 1230 may be configured for reducing a plurality of toxins. Further, the floatation device 1230 may be configured for storing the at least one output particle in a container. Further, the floatation device 1230 may be configured for adding a plurality of magnetic beads to the container. Further, the floatation device 1230 may be configured for adding a water-soluble adsorbent to the container. Further, the floatation device 1230 may be configured for smearing a specific metal water-soluble adsorption material to adsorb at least one toxin. Further, the system may include a magnetic field device 1232 mechanically coupled with the floatation device 1230. Further, the magnetic field device 1232 may be configured for recovering the target particle. Further, the magnetic field device 1232 may be configured for attracting the plurality of magnetic beads for collection. Further, the system may include a gravitational device 1220 mechanically coupled with the grinding device. Further, the gravitational device 1220 may be configured for inputting waste from electronic equipment, waste from mines, waste from tailing, or waste from silt. Further, the gravitational device 1220 may be configured for separating clay and metal. Further, the gravitational device 1220 may be configured for treating at least one toxin. Further, the gravitational device 1220 may be configured for reducing at least one toxin. Further, the gravitational device 1220 may be configured for screening at least one target particle. Further, the gravitational device 1220 may be configured for classifying at least one target particle. Further, the gravitational device 1220 may be configured for receiving at least one target particle. Further, the system may include a biological device 1260 coupled with the floatation device 1230. Further, the biological device 1260 may be configured for adsorbing at least one target particle with a plurality of positive ions. Further, the biological device 1260 may be configured for separating at least one target particle from a mixture. Further, the biological device 1260 may be configured for testing the charge of the microorganism. Further, the biological device 1260 may be configured for selecting the species of the microorganism. Further, the biological device 1260 may be configured for designing the excitation charge of the microorganism. Further, the biological device 1260 may be configured for evaluating the artificial intelligence control environment based on the microorganism. Further, the biological device 1260 may be configured for pouring a mixture into a microbial pool. Further, the biological device 1260 may be configured for sieving the mixture in the microbial pool. Further, the biological device 1260 may be configured for decomposing the mixture in the microbial pool. Further, the biological device 1260 may be configured for injecting at least one ground up material into the microbial pool.

Although the invention has been explained in relation to its preferred embodiment, it is to be understood that many other possible modifications and variations can be made without departing from the spirit and scope of the invention as hereinafter claimed.

What is claimed is:

1. A method for facilitating green screening, classification, and adsorption of target elements from a mixture comprising the steps of:
receiving a mixture;
separating clay and metal constituted in the mixture;
treating pollutants or toxins constituted in the mixture with magnetic beads;
treating the pollutants or toxins using nano bubbles generated by a 3-in-one bubble generator;
screening and classifying the tiny particles constituted in the mixture based on magnetic separation;
screening and classifying the tiny particles constituted in the mixture based on gravity separation;
screening and classifying the tiny particles constituted in the mixture based on floatation; and
collecting the target element and rare earth elements.

2. The method for facilitating green screening, classification, and adsorption of target elements from a mixture as claimed in claim 1 comprising:
grinding and separating, with the grinding system, the mixture; and
presenting, using the processing device, a gravity subprocess and a floatation subprocess.

3. The method for facilitating green screening, classification, and adsorption of target elements from a mixture as claimed in claim 2 comprising:
selecting, using the processing device, the gravity subprocess based on mixture conditions;
filtering, with a sieve device, the mixture when a target particle size is different from the waste particle size; and
concentrating, with a centrifugal device, at least one output particle.

4. The method for facilitating green screening, classification, and adsorption of target elements from a mixture as claimed in claim 3 comprising:
integrating, using a 3-in-1 generator, three types of bubbles;
monitoring, using a photographic observation system, the mixture;
differentiating, using the photographic observation system, at least one particle; and
receiving, using a photographic observation system, environmental commands.

5. The method for facilitating green screening, classification, and adsorption of target elements from a mixture as claimed in claim 4 comprising:
adjusting, using the 3-in-1 generator, the recovery rate; and
adjusting, using the 3-in-1 generator, the bubble size and arrangement order of each size.

6. The method for facilitating green screening, classification, and adsorption of target elements from a mixture as claimed in claim 4 comprising:
photographing, using the photographic observation system, the particle distribution;
analyzing, using a processing device, the at least one particle size, the at least one particle quantity, and the at least one particle type;
selecting, using the processing device, a bubble size and arrangement order strategy; and
adjusting, using the 3-in-1 generator, the air pressure, temperature, PH value, adjuvant dosage, and adjuvant type.

7. The method for facilitating green screening, classification, and adsorption of target elements from a mixture as claimed in claim 2 comprising:
selecting, using the processing device, the floatation subprocess when the weight of a target particle is equal to the waste particle;
selecting, using the floatation device, a micro-bubble size or a nano-bubble sized based on the mixture conditions;
recovering, using the magnetic field device, the target particle;
treating, using the floatation device, a plurality of toxins; and
reducing, using the floatation device, a plurality of toxins.

8. The method for facilitating green screening, classification, and adsorption of target elements from a mixture as claimed in claim 7 comprising:
storing, using the floatation device, the at least one output particle in a container;
adding, using the floatation device, a plurality of magnetic beads to the container;
adding, using the floatation device, a water-soluble adsorbent to the container;
smearing, using the floatation device, a specific metal water-soluble adsorption material to adsorb at least one toxin;
attracting, using a magnetic field device, the plurality of magnetic beads for collection; and
dispersing, using the sieve device, the plurality of magnetic beads to filter and recover at least one toxin.

9. The method for facilitating green screening, classification, and adsorption of target elements from a mixture as claimed in claim 8 comprising:
inputting, using a gravitational device, waste from electronic equipment, waste from mines, waste from tailing, or waste from silt;
separating, using the gravitational device, clay and metal;
treating, using the gravitational device, at least one toxin;
reducing, using the gravitational device, at least one toxin;
screening, using the gravitational device, at least one target particle;
classifying, using the gravitational device, at least one target particle; and
receiving, using the gravitational device, at least one target particle.

10. The method for facilitating green screening, classification, and adsorption of target elements from a mixture as claimed in claim 1 comprising:
selecting, using the processing device, charged microorganisms;
adsorbing, using the biological device, at least one target particle with a plurality of positive ions;
separating, using the biological device, at least one target particle from a mixture; and
grinding, using the grinding system, at least one target particle into a plurality of fine balls.

11. The method for facilitating green screening, classification, and adsorption of target elements from a mixture as claimed in claim 1 comprising:
establishing, using a processing device, an artificial intelligence control environment;
selecting, using the processing device, a microorganism;
testing, using the biological device, the charge of the microorganism;
selecting, using the biological device, the species of the microorganism;
designing, using the biological device, the excitation charge of the microorganism;
evaluating, using the biological device, the artificial intelligence control environment based on the microorganism;
pouring, using the biological device, a mixture into a microbial pool;
sieving, using the biological device, the mixture in the microbial pool;
decomposing, using the biological device, the mixture in the microbial pool;
injecting, using the biological device, at least one ground up material into the microbial pool; and
adjusting, using the biological device, a charge volume in the decomposition of the microbial pool.

12. A method for facilitating green screening, classification, and adsorption of target elements from a mixture comprising the steps of:
receiving a mixture;
separating clay and metal constituted in the mixture;
treating pollutants or toxins constituted in the mixture with magnetic beads;
treating the pollutants or toxins using nano bubbles generated by a 3-in-one bubble generator;
screening and classifying the tiny particles constituted in the mixture based on magnetic separation;
screening and classifying the tiny particles constituted in the mixture based on gravity separation;
screening and classifying the tiny particles constituted in the mixture based on floatation;
collecting the target element and rare earth elements;
grinding and separating, with the grinding system, the mixture;
presenting, using the processing device, a gravity subprocess and a floatation subprocess;
selecting, using the processing device, the gravity subprocess based on mixture conditions;
filtering, with a sieve device, the mixture when a target particle size is different from the waste particle size; and
concentrating, with a centrifugal device, at least one output particle.

13. The method for facilitating green screening, classification, and adsorption of target elements from a mixture as claimed in claim 12 comprising:
integrating, using a 3-in-1 generator, three types of bubbles;
monitoring, using a photographic observation system, the mixture;
differentiating, using the photographic observation system, at least one particle;
receiving, using a photographic observation system, environmental commands;
adjusting, using the 3-in-1 generator, the recovery rate;
adjusting, using the 3-in-1 generator, the bubble size and arrangement order of each size;
photographing, using the photographic observation system, the particle distribution;
analyzing, using a processing device, the at least one particle size, the at least one particle quantity, and the at least one particle type;
selecting, using the processing device, a bubble size and arrangement order strategy; and
adjusting, using the 3-in-1 generator, the air pressure, temperature, PH value, adjuvant dosage, and adjuvant type.

14. The method for facilitating green screening, classification, and adsorption of target elements from a mixture as claimed in claim 12 comprising:
selecting, using the processing device, the floatation subprocess when the weight of a target particle is equal to the waste particle;
selecting, using the floatation device, a micro-bubble size or a nano-bubble sized based on the mixture conditions;
recovering, using the magnetic field device, the target particle;
treating, using the floatation device, a plurality of toxins;
reducing, using the floatation device, a plurality of toxins;
storing, using the floatation device, the at least one output particle in a container;
adding, using the floatation device, a plurality of magnetic beads to the container;
adding, using the floatation device, a water-soluble adsorbent to the container;
smearing, using the floatation device, a specific metal water-soluble adsorption material to adsorb at least one toxin;
attracting, using a magnetic field device, the plurality of magnetic beads for collection;
dispersing, using the sieve device, the plurality of magnetic beads to filter and recover at least one toxin;
inputting, using a gravitational device, waste from electronic equipment, waste from mines, waste from tailing, or waste from silt;
separating, using the gravitational device, clay and metal;
treating, using the gravitational device, at least one toxin;
reducing, using the gravitational device, at least one toxin;
screening, using the gravitational device, at least one target particle;
classifying, using the gravitational device, at least one target particle; and
receiving, using the gravitational device, at least one target particle.

15. The method for facilitating green screening, classification, and adsorption of target elements from a mixture as claimed in claim 12 comprising:
selecting, using the processing device, charged microorganisms;
adsorbing, using the biological device, at least one target particle with a plurality of positive ions;
separating, using the biological device, at least one target particle from a mixture;
grinding, using the grinding system, at least one target particle into a plurality of fine balls;
establishing, using a processing device, an artificial intelligence control environment;
selecting, using the processing device, a microorganism;
testing, using the biological device, the charge of the microorganism;
selecting, using the biological device, the species of the microorganism;
designing, using the biological device, the excitation charge of the microorganism;
evaluating, using the biological device, the artificial intelligence control environment based on the microorganism;
pouring, using the biological device, a mixture into a microbial pool;
sieving, using the biological device, the mixture in the microbial pool;
decomposing, using the biological device, the mixture in the microbial pool;
injecting, using the biological device, at least one ground up material into the microbial pool; and
adjusting, using the biological device, a charge volume in the decomposition of the microbial pool.

16. A system for facilitating green screening, classification, and adsorption of target elements from a mixture, the system comprising:
a processing device;
a photographic observation system;
a gravitational device;
a floatation device;
a grinding system;
a biological device;
the photographic observation system further comprising an electron microscope, a camera, and an infrared device;
the gravitational device further comprising a shaker table, a sieve device, and a centrifugal device;
the floatation device further comprising a 3-in-1 generator and a magnetic field device; and
the grinding system further comprising an anti-leakage net.

17. The system for facilitating green screening, classification, and adsorption of target elements from a mixture as claimed in claim 16 wherein:
the grinding system configured for:
grinding and separating the mixture;
the processing device configured for:
presenting a gravity subprocess and a floatation subprocess;
selecting the gravity subprocess based on mixture conditions;
the sieve device configured for:
filtering the mixture when a target particle size is different from the waste particle size; and
the centrifugal device configured for:
concentrating at least one output particle.

18. The system for facilitating green screening, classification, and adsorption of target elements from a mixture as claimed in claim 17 wherein:
the 3-in-1 generator configured for:
integrating three types of bubbles;
adjusting the recovery rate;
adjusting the bubble size and arrangement order of each size;
adjusting the air pressure, temperature, PH value, adjuvant dosage, and adjuvant type;
the photographic observation device configured for:
monitoring the mixture;
differentiating at least one particle;
receiving environmental commands;
photographing the particle distribution;
the processing device further configured for:
analyzing the at least one particle size, the at least one particle quantity, and the at least one particle type; and
selecting a bubble size and arrangement order strategy.

19. The system for facilitating green screening, classification, and adsorption of target elements from a mixture as claimed in claim 16 wherein:
the processing device further configured for:
selecting the floatation subprocess when the weight of a target particle is equal to the waste particle;
the floatation device configured for:
selecting a micro-bubble size or a nano-bubble sized based on the mixture conditions;
treating a plurality of toxins;
reducing a plurality of toxins;
storing the at least one output particle in a container;
adding a plurality of magnetic beads to the container;
adding a water-soluble adsorbent to the container;
smearing a specific metal water-soluble adsorption material to adsorb at least one toxin;
the magnetic field device configured for:
recovering the target particle;
attracting the plurality of magnetic beads for collection;
the sieve device further configured for:
dispersing, using the sieve device, the plurality of magnetic beads to filter and recover at least one toxin;
the gravitational device configured for:
inputting waste from electronic equipment, waste from mines, waste from tailing, or waste from silt;
separating clay and metal;
treating at least one toxin;
reducing at least one toxin;
screening at least one target particle;
classifying at least one target particle; and
receiving at least one target particle.

20. The system for facilitating green screening, classification, and adsorption of target elements from a mixture as claimed in claim 16 wherein:
the processing device is further configured for:
selecting charged microorganisms;
establishing an artificial intelligence control environment;
selecting a microorganism;
the biological device configured for:
adsorbing at least one target particle with a plurality of positive ions;
separating at least one target particle from a mixture;
testing the charge of the microorganism;
selecting the species of the microorganism;
designing the excitation charge of the microorganism;
evaluating the artificial intelligence control environment based on the microorganism;
pouring a mixture into a microbial pool;
sieving the mixture in the microbial pool;
decomposing the mixture in the microbial pool;
injecting at least one ground up material into the microbial pool;
the grinding system configured for:
grinding at least one target particle into a plurality of fine balls; and
adjusting, using the biological device, a charge volume in the decomposition of the microbial pool.
